(19) United States
(12) Patent Application Publication
(10) Pub. No.: US 2026/0356233 A1
(43) Pub. Date: Nov. 12, 2026

(54) SYSTEMS AND METHODS FOR APPLICATION SELECTION FOR SECURE REMOTE COMMERCE TRANSACTIONS

(71) Applicant: Mastercard International Incorporated, Purchase, NY (US)

(72) Inventors: Patrik Smets, Begijnendijk (BE); Mohamed Abouelenin, San Carlos, CA (US)

(73) Assignee: Mastercard International Incorporated, Purchase, NY (US)

(21) Appl. No.: 19/200,915

(22) Filed: May 7, 2025

(51) Int. Cl. B60L 53/66; B60L 53/30; G06Q 20/34

(52) U.S. Cl. CPC B60L 53/665; B60L 53/305; G06Q 20/356

(57) ABSTRACT

Techniques for processing electric vehicle (EV) charging transactions using an EV computing system and a charging station (CS) computing system are disclosed. The techniques include establishing communication between the EV and the CS via one or more communication protocols. The EV receives a list of supported payment applications from the CS and retrieves stored transaction cards from its memory. The EV matches the payment application and transaction cards to generate a candidate list of compatible transaction cards. The candidate list is prioritized based on predefined rules, enabling the EV to select a prioritized transaction card for processing the transaction. The techniques may include matching labels associated with the transaction cards to support loyalty programs and merchant-specific benefits. Payment information, including tokens, may be securely transmitted for authorization processing. The techniques ensure efficient and flexible payment processing for unattended EV charging transactions.

### BACKGROUND

The disclosure relates to unattended payment systems, and more particularly, to digital payment application selection for unattended payment systems, such as electric vehicle (EV) charging, by enabling seamless and secure transactions through frameworks like Secure Remote Commerce (SRC).

The growing adoption of EVs highlights the need for seamless and interoperable payment solutions for EV charging infrastructure. Existing protocols like ISO 15118 already manage digital communication between the EV and the charging station to facilitate charging parameters such as energy requirements and session time. However, a critical gap remains in integrating efficient, user-friendly, unattended payment mechanisms that align with current and emerging payment technologies.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, an electric vehicle (EV) computing system is provided. The EV computing system includes one or more processors and a memory device storing one or more transaction cards thereon. The memory device also includes computer-executable instructions stored thereon, which when executed by the one or more processors, causes the one or more processors to establish a communication channel with a charging station (CS) computing system via one or more communication protocols. The processors receive a list of supported payment applications from the CS computing system. Additionally, the processors retrieve the one or more stored transaction cards from the memory device. The one or more processors match the one or more stored transaction cards to the list of supported payment applications. Based on the matching, the processors generate a candidate list of transaction cards compatible with the CS computing system. Furthermore, the one or more processors prioritize the candidate list of transaction cards based on one or more predefined rules. The one or more processors also select a prioritized transaction card for processing a transaction at the CS computing system.

In another aspect, a method is provided. The method includes establishing a communication channel between an electric vehicle (EV) computing system and a charging station (CS) computing system via one or more communication protocols. The method also includes receiving, by the EV computing system, a list of supported payment applications from the CS computing system. Furthermore, the method includes retrieving, by the EV computing system, one or more stored transaction cards from a memory device of the EV computing system. Additionally, the method includes matching, by the EV computing system, the one or more stored transaction cards to the list of supported payment applications. The method also includes generating, based on the matching and by the EV computing system, a candidate list of transaction cards compatible with the CS computing system. Furthermore, the method includes prioritizing, by the EV computing system, the candidate list of transaction cards based on one or more predefined rules. In addition, the method includes selecting, by the EV computing system, a prioritized transaction card for processing a transaction at the CS computing system.

A variety of additional aspects will be set forth in the detailed description that follows. These aspects can relate to individual features and to combinations of features. The advantages of these and other aspects will be apparent to those skilled in the art from the following description of the exemplary embodiments which have been shown and described by way of illustration. As will be realized, the details of the present aspects described herein may be modified in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram depicting an exemplary multi-party payment processing system and network for processing payment transactions, including vehicle charging transactions, in accordance with an aspect of the present disclosure;

FIG. 2 is an example configuration of an electric vehicle for use with the system of FIG. 1;

FIG. 3 is an example configuration of a charging station for use with the system of FIG. 1;

FIG. 4 is an example configuration of a server system for use with the system of FIG. 1; and

FIG. 5 is a process flow diagram for an electrical energy charging transaction between the electric vehicle of FIG. 2 and the charging station of FIG. 3, in accordance with an aspect of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to charging electric vehicles. The scope of the present invention is defined only by the appended claims, along with the full scope of equivalents to which such claims are entitled.

### Example System

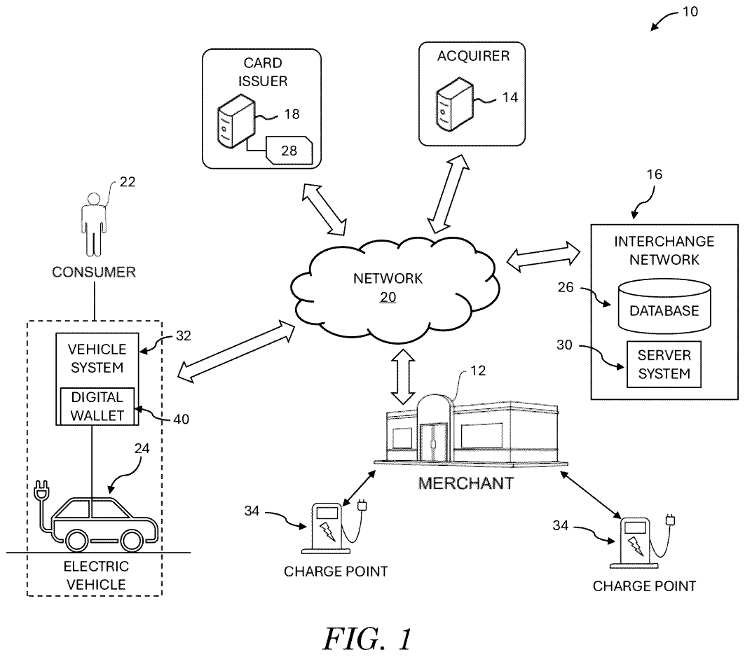

FIG. 1 is a block diagram depicting an exemplary multi-party payment processing system and network 10 for processing payment transactions, including vehicle charging transactions. Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of the Mastercard interchange network. Embodiments described herein may also relate to digital payment services such as “Click to Pay,” a unified digital payments service offered by Mastercard, or another digital wallet service for a mobile device such as a smartphone.

In the exemplary embodiment, the system 10 facilitates providing interchange network services offered by an interchange network 16. In addition, the system 10 enables payment card transactions in which a merchant 12, an acquirer 14, and/or a card issuer 18 do not need to have a one-to-one relationship. Although parts of the system 10 are presented in one arrangement, other embodiments may include the same or different parts arranged otherwise, depending, for example, on authorization processes for purchase transactions, communication between computing devices, etc.

In the example embodiment, the merchant 12, the acquirer 14, the interchange network 16, and the issuer 18 may be coupled together in communication via a network 20. The network 20 may include, for example and without limitation, one or more of a local area network (LAN), a wide area network (WAN) (e.g., the Internet, etc.), a mobile network, a virtual network, and/or any other suitable public and/or private network capable of facilitating communication among the merchant 12, the acquirer 14, the interchange network 16, and/or the issuer 18. In some embodiments, the network 20 may include more than one type of network, such as a private payment transaction network provided by the interchange network 16 to the acquirer 14 and the issuer 18 and, separately, the public Internet, which may facilitate communication between the merchant 12, the interchange network 16, the acquirer 14, and a consumer 22 (also referred to as a “customer,” “cardholder,” and “user”), etc.

In the example system 10, a financial institution called the “issuer,” such as the issuer 18, issues one or more transaction card accounts 28, such as a consumer credit card or a debit card, to the consumer 22. The consumer 22 uses one of the one or more transaction card accounts 28 to tender payment for a purchase from a merchant, such as the merchant 12. The consumer 22 may input information from the transaction card accounts 28 into a vehicle system 32 and store the information in a vehicle digital wallet 40. The information may be stored as digital wallet data (broadly, payment credentials).

The vehicle system 32 may include, for example, a computing device integrated with the electric vehicle 24 or a consumer computing device paired with the electric vehicle 24, such as a cellular telephone, a smart watch or other electronic wearable apparel, a tablet, an implanted smart device, a personal computing device, or any other electronic device capable of two-way digital communications which may be associated with the consumer 22 and the electric vehicle 24. In some embodiments, the vehicle system 32 may be replaced with another computing device suitable for performing the functions disclosed herein

The merchant 12 is typically associated with goods and/or services offered for sale and sold to the consumer 22. In particular, the merchant 12 may be associated with operating one or more vehicle charging stations, such as charging station (CS) 34, that are configured to provide electrical energy to electric vehicles, such as the electric vehicle 24. The merchant 12 includes, for example, a physical location and/or a virtual location such as an Internet-based storefront.

To accept payment from the consumer 22, for example, with the payment credentials (or digital wallet data) stored in the digital wallet 40, the merchant 12 must normally establish an account with a financial institution that is part of the system 10. This financial institution is usually called the “merchant bank,” the “acquiring bank,” or the acquirer 14. When the consumer 22 submits payment for a purchase with the vehicle system 32 using the digital wallet 40, for example, the merchant 12 requests authorization from the acquirer 14 for the purchase. The request may be performed over a telephone but is usually performed using a point-of-sale (POS) terminal that reads the consumer's account information from a magnetic stripe, a chip, embossed characters on the transaction card, or digital wallet data. The POS terminal communicates electronically with the transaction processing computers of the acquirer 14. Alternatively, the acquirer 14 may authorize a third party to perform transaction processing on its behalf. In this case, the POS terminal will be configured to communicate with the third party. Such a third party is usually called a “merchant processor,” an “acquiring processor,” or a “third party processor.”

Using the interchange network 16, the computers of the acquirer 14 or the merchant processor will communicate with computers of the issuer 18 to determine whether the consumer's account is in good standing and whether the purchase is covered by the consumer's available credit line or account balance. Based on these determinations, the request for authorization will be declined or accepted. If the request is accepted, a bank network reference number, an authorization code, and/or other transaction identifier(s) that may be used to identify the transaction is issued to the merchant 12.

The interchange network 16 may be configured to process authorization messages, such as ISO® 8583 compliant messages and ISO® 20022 compliant messages. As used herein, “ISO®” includes a series of standards approved by the International Organization for Standardization (ISO is a registered trademark of the International Organization for Standardization of Geneva, Switzerland). ISO 8583 compliant messages are defined by the ISO 8583 standard that governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

During the authorization process of the system 10, a clearing process is also taking place. During the clearing process, the acquirer 14 provides the issuer 18 with information relating to the sale. No money is exchanged during clearing. Clearing (also referred to as “first presentment”) involves the exchange of data required to identify the consumer's transaction card account 28, such as the account number, expiration date, billing address, amount of the sale, and/or other transaction identifiers that may be used to identify the transaction. Along with this data, banks in the United States also include a bank network reference number, such as a Banknet Reference Number used by Mastercard, which identifies the specific transaction. When the issuer 18 receives this data, the issuer 18 posts the amount of sale as a draw against the available credit in the consumer's transaction card account 28 and prepares to send payment to the acquirer 14.

When a request for authorization is accepted, the available credit line of the consumer's transaction card account 28 is decreased. Normally, a charge for a payment card transaction is not posted immediately to the consumer's transaction card account 28 because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on a POS terminal. This may include bundling of approved transactions daily for standard retail purchases. If the consumer 22 cancels a transaction before it is captured, a “void” is generated. If the consumer 22 returns goods after the transaction has been captured, a “credit” is generated. The interchange network 16 and/or the issuer 18 stores the payment card information, such as, and without limitation, a type of merchant, a merchant identifier, a location where the transaction was completed, an amount of purchase, and a date and time of the transaction, in a database 26.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. In some embodiments, transactions are captured and accumulated into a “batch,” which is settled as a group. In other embodiments, the transactions are captured and settled individually or in a group in substantially real-time. More specifically, a transaction is typically settled between the issuer 18 and the interchange network 16, and then between the interchange network 16 and the acquirer 14, and then between the acquirer 14 and the merchant 12.

In some embodiments, the payment card transaction is a card-not-present (CNP) transaction conducted, for example, with a payment card or payment card data stored on file with the merchant 12 or stored as digital wallet data in the digital wallet 40 on a consumer's computing device, such as the vehicle system 32. Alternatively, the payment card transaction may be a card present transaction conducted, for example, by swiping or dipping a payment card at the merchant's POS terminal. In the example embodiment, the vehicle system 32 and the digital wallet 40 may be integrated with the electric vehicle 24 as an onboard computing system or may include a consumer computing device paired with the electric vehicle 24, such as a cellular telephone, a smart watch or other electronic wearable apparel, a tablet, an implanted smart device, a personal computing device, or any other electronic device capable of two-way digital communications that may be associated with the consumer 22 and the electric vehicle 24.

The vehicle system 32 may additionally be configured to assist the consumer 22 with setting up an account with the merchant 12. During the account setup process, the consumer 22 may transmit account registration information to the merchant 12, via the vehicle system 32. The account registration information may include, for example, and without limitation, payment account data (e.g., one or more primary account numbers (PANs), virtual payment numbers, limited use numbers, etc.) and user system identification data (e.g., a vehicle identification number (VIN), Electronic Serial Number (ESN), Mobile Equipment Identifier (MEID), International Mobile Equipment Identity (IMEI) number, and the like). For example, the merchant 12 may receive account registration information from the vehicle system 32 identifying the vehicle system 32 and one or more payment accounts or PANs associated with the consumer 22. The consumer 22 may, for example, set up the account with the merchant 12 by providing the account registration information and generating a login identifier (i.e., a UserID) and a password used when logging into an application for communicating with the merchant 12. The consumer 22 may transmit various information or data to the merchant 12 via an application, which may be stored on, partially stored on, or accessed via a web-browser of the vehicle system 32. The information or data transmitted by the consumer 22 to the merchant 12 may also include, for example, authentication information associated with the consumer's PAN, biometrics of the consumer, and/or contact information. The contact information may include one or more ways to communicate with the consumer 22, including, for example, via a push notification associated with the application, a short messaging service (SMS) message, an email message, a telephone number, and the like. The merchant 12 may generate a new account profile or update an existing account profile for the account associated with the account registration information received from the vehicle system 32. Payment information associated with the account may be stored in the digital wallet 40. Alternatively or in addition, in some embodiments, another consumer computing device (not shown), such as a cellular telephone, a smart watch or other electronic wearable apparel, a tablet, an implanted smart device, a personal computing device, etc., capable of capable of two-way digital communications via the network 20 may be used by the consumer 22 to setup the account with the merchant 12.

In the example embodiment, the interchange network 16 includes a server system 30 coupled in communication with the merchant 12 and associated CSs 34, the acquirer 14, and the issuer 18. The server system 30 is also coupled in communication with a one or more client systems, such as the vehicle system 32 and other user or vehicle systems. In one embodiment, the vehicle system 32 is a computing device that includes a web browser or interface, such that the server system 30 is accessible to the vehicle system 32 using the Internet. The vehicle system 32 is interconnected to the Internet through one or more interfaces including, for example, a network, such as: a LAN or WAN, dial-in-connections, cable modems, and/or special high-speed Integrated Services Digital Network (ISDN) lines; and/or with a mobile phone network, such as Global System for Mobile communications (GSM), 3G, 4G, 5G, or other mobile data network; and/or Worldwide Interoperability for Microwave Access (WiMax) and the like. The vehicle system 32 can be any device capable of interconnecting to the Internet including an Internet connected phone, a PDA, or any other suitable web-based connectable equipment.

The one or more CSs 34 may be connected to the merchant 12 and to the server system 30. The CSs 34 may be interconnected to the Internet (or any other network that allows the CSs 34 to communicate as described herein) through any one or more suitable interfaces including, for example, a network, such as: a LAN or WAN, dial-in-connections, cable modems, and/or special high-speed Integrated Services Digital Network (ISDN) lines; and/or with a mobile phone network, such as Global System for Mobile communications (GSM), 3G, 4G, 5G, or other mobile data network; and/or Worldwide Interoperability for Microwave Access (WiMax) and the like. Each of the CSs 34 may include any device capable of interconnecting to the Internet and including an input device capable of reading information received from the digital wallet 40 of the vehicle system 32.

In the example embodiment, the server system 30 is connected to the database 26, which is configured to store information on a variety of matters, including account information associated with consumers, such as the consumer 22. In one embodiment, the database 26 is a centralized database stored on the server system 30. In an alternative embodiment, the database 26 is stored remotely from the server system 30 and may be a distributed or non-centralized database. In an embodiment, the database 26 may include a single database having separated sections or partitions or may include multiple databases, each being separate from each other. The database 26 may store transaction data generated as part of sales activities and savings activities conducted over the processing network including data relating to merchants, account holders or customers, issuers, acquirers, savings amounts, savings account information, and/or purchases made. The database 26 may also store account data including at least one of a consumer name, a consumer address, an account number, and other account identifier. The database 26 may also store merchant data including a merchant identifier that identifies each merchant registered to use the network, and instructions for settling transactions including merchant bank account information. The database 26 may also store purchase data associated with items being purchased by a consumer from a merchant, and authorization request data. The database 26 may also store device information, payment card information, and other data involved with processing transactions between one or more parties.

It is noted that the system 10 may include more, fewer, or alternative components and/or perform more, fewer, or alternative actions, including those discussed elsewhere herein.

### Exemplary Computer Systems

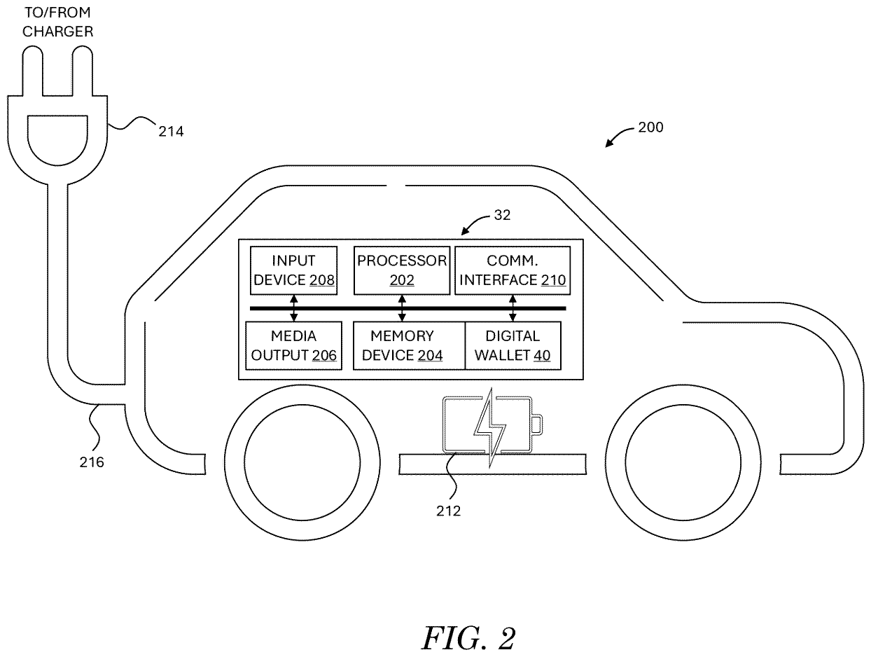

FIG. 2 is an example configuration of an electric vehicle (EV) 200, such as the EV 24 (shown in FIG. 1). In the example embodiment, the EV 200 includes the integrated vehicle system 32, a battery 212 (broadly, a power source), and an electrical connector 214. The electrical connector 214 may be integrated with the battery 212 or may be attached to an electrical cable 216 coupled to the battery 212.

In the example, the vehicle system 32 includes one or more processors 202 (e.g., in a multi-core configuration) for executing computer readable instructions. The instructions may be executed within a variety of different operating systems (OS) on the vehicle system 32, such as UNIX, LINUX, Microsoft Windows®, etc. More specifically, the instructions may cause various data manipulations on data stored in a memory device 204 (e.g., create, read, write, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C #, C++, Java, or other suitable programming languages, etc.). In some embodiments, the executable instructions are stored in the memory device 204. The memory device 204 is any device allowing information such as digital wallet data, executable instructions, and the like to be stored thereon and retrieved therefrom. The memory device 204 includes one or more computer readable media.

In the example embodiment, the processor 202 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

In some embodiments, the vehicle system 32 includes at least one media output component 206 for presenting information to a user, such as the consumer 22 (shown in FIG. 1). The media output component 206 is any component capable of conveying information to the consumer 22. In some embodiments, the media output component 206 includes an output adapter such as a video adapter and/or an audio adapter. An output adapter is operatively coupled to the processor 202 and operatively connectable to an output device such as a display device, a liquid crystal display (LCD), organic light emitting diode (OLED) display, or “electronic ink” display, or an audio output device, a speaker, or headphones.

In some embodiments, the vehicle system 32 includes an input device 208 for receiving input from the consumer 22. The input device 208 may include, for example, a touch sensitive panel, a touch pad, a touch screen, a stylus, a gyroscope, an accelerometer, a position detector, a keyboard, a pointing device, a mouse, or an audio input device. A single component, such as a touch screen, may function as both an output device of the media output component 206 and the input device 208.

The vehicle system 32 may also include a communication interface 210, which is communicatively connectable to one or more remote computing devices, such as the server system 30 (shown in FIG. 1) and/or the CSs 34 (shown in FIG. 1). The communication interface 210 may include, for example, a wired or wireless network adapter or a wireless data transmitter or transceiver for use with Bluetooth communication, radio frequency (RF) communication, AM/FM frequency broadcasts, near field communication (NFC); and/or with a mobile phone network, such as Global System for Mobile communications (GSM), 3G, 4G, 5G, or other mobile data network; and/or Worldwide Interoperability for Microwave Access (WiMax) and the like.

Stored in the memory device 204 are, for example, computer readable instructions for providing a user interface to the consumer 22 via the media output component 206 and, optionally, receiving and processing input from the input device 208 and/or communication interface 210. A user interface may include, among other possibilities, a web browser and a client application. Web browsers enable users, such as the consumer 22, to display and interact with media and other information typically embedded on a web page or a website, for example, provided by the server system 30. A client application allows the consumer 22 to interact with, for example, a server application from the server system 30 and/or an interface from the CSs 34 or merchant 12. In the example embodiment, the memory device 204 may include the digital wallet 40 and may store digital wallet data corresponding to the digital wallet 40.

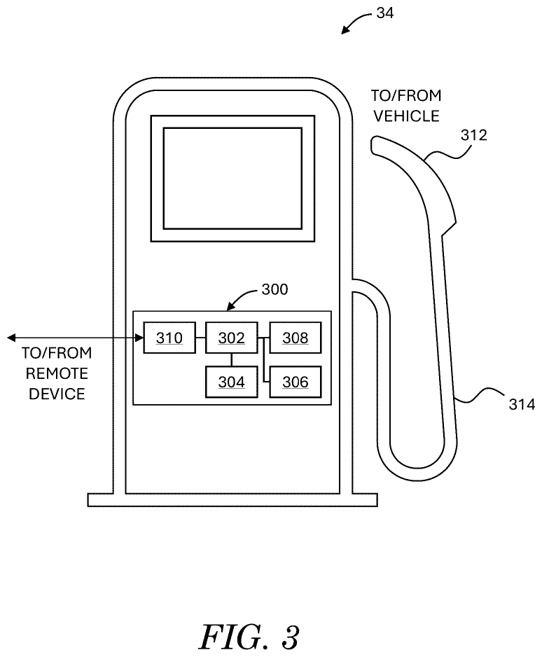

In the example embodiment, the electrical connector 214 is configured to attach to a corresponding electrical connector of a CS 34, such as an electrical connector 312 (shown in FIG. 3). After the electrical connector 214 is attached to the corresponding electrical connector 312 of the CS 34, electronic communication may be established between the vehicle system 32 and the CS 34, and more particularly, a computing system 300 (shown in FIG. 3) of the CS 34. In the exemplary embodiment, both electronic data and electrical energy may be transferred to the EV 200 via the electrical connector 214 and electrical cable 216.

In an embodiment, the CS 34 and/or the EV 200 communicates with various components of the system 10 (shown in FIG. 1) to authorize a transaction to allow a transfer of electrical energy from the CS 34 to the EV 200. In some embodiments, the EV 200 may be configured to receive, for example, one hundred and twenty (120) volts alternating current (VAC), two hundred and forty (240) VAC, direct current (DC) power, or any other form of electrical energy from a corresponding CS 34.

Electrical energy that is received by the EV 200 may be provided to the battery 212 as a charging current. In some embodiments, the EV 200 may include various circuitry components (not shown), such as an input filter, a rectifier, one or more AC/DC and/or DC/DC converters, current sensors, voltage sensors, fault protection circuitry, and/or any other circuitry necessary to provide the charging current to the battery 212.

In some embodiments, the electrical connector 214 may be an electrical plug configured to be received by a corresponding electrical connector of a CS, such as the electrical connector 312 of the CS 34 (shown in FIG. 3). Alternatively, the electrical connector 214 may be a receptacle configured to receive a corresponding electrical connector 312 of the CS 34. In an alternative embodiment, the electrical connector 214 may be an inductive charging coil configured to wirelessly transfer and/or receive electronic data and electrical energy.

In some embodiments, the battery 212 may include one or more lithium-ion batteries, nickel-metal hydride batteries, lead-acid batteries, ultracapacitors a capacitor bank, and the like. The battery 212 may provide electrical power to various electronic components of the EV 200 including at least one or more electric motors (not shown), one or more auxiliary batteries (not shown), an electronic control unit (not shown), a vehicle display (not shown), the vehicle system 32, and any other electronic circuitry requiring electric power as part of the operation of the EV 200.

As discussed in more detail below, in an example embodiment, upon detecting a connection with a CS 34, the vehicle system 32 may establish communication with the connected CS 34. The CS 34 may transmit merchant information to the EV 200. Subsequently, the EV 200 may retrieve payment information from the digital wallet 40 and provide the payment information to the connected CS 34 via the communication interface 210. After the payment information is processed, the EV 200 may begin to receive a charging current from the CS 34.

FIG. 3 is an example configuration of a charging station (CS) 34 including an integrated computing system 300. In the example, the CS 34 is operated by a charging station operator, such as the merchant 12 (shown in FIG. 1). In the exemplary embodiment, the CS 34 includes an electrical connector 312, a charging cable 314, and the computing system 300. The charging cable 314 and electrical connector 312 are configured to transmit both electronic data and electrical energy between the CS 34 and an EV, such as the EV 200 (shown in FIG. 2). The electrical connector 312 is configured to connect to a corresponding electrical connector of an EV, such as the electrical connector 214 of the EV 200 (shown in FIG. 2). The computing system 300 is configured to process electronic data and communicate with various components of the system 10 (shown in FIG. 1).

In the example, the computing system 300 includes a processor 302 for executing instructions. In some embodiments, executable instructions are stored in a memory device 304. The processor 302 includes one or more processing units, for example, defining a multi-core configuration. The memory device 304 is any device allowing information such as payment transaction data, executable instructions, and the like to be stored thereon and retrieved therefrom. The memory device 304 includes one or more computer readable media.

In the example embodiment, the processor 302 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

The computing system 300 preferably may also include at least one media output component 306 for presenting information to a user. The media output component 306 may be any component capable of conveying information to a user, such as the consumer 22 (shown in FIG. 1). In some embodiments, the media output component 306 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the computing system 300 includes an input device 308 for receiving input from a user. The input device 308 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 306 and the input device 308.

The computing system 300 also includes a communication interface 310, which is communicatively connectable to a remote device, such as the server system 30 (shown in FIG. 1) and/or the merchant 12 (shown in FIG. 1). The communication interface 310 may include, for example, a wired or wireless network adapter or a wireless data transmitter or transceiver. A wired or wireless network adapter may enable connection to a network, such as: a LAN or WAN, dial-in-connections, cable modems, and/or special high-speed Integrated Services Digital Network (ISDN) lines. A wireless data transmitter or transceiver may be configured to for use with Bluetooth communication, radio frequency (RF) communication, AM/FM frequency broadcasts, near field communication (NFC); and/or with a mobile phone network, such as Global System for Mobile communications (GSM), 3G, 4G, 5G, or other mobile data network; and/or Worldwide Interoperability for Microwave Access (WiMax) and the like.

In a preferred embodiment, stored in the memory device 304 are, for example, computer readable instructions for providing a user interface to a user, for example, via the media output component 306 and, optionally, receiving and processing input from the input device 308 and/or the communication interface 310. A user interface may include, among other possibilities, a web browser and a client application. Web browsers enable users to view and interact with media and other information typically embedded on a web page or a website, for example, provided by the server system 30. A client application allows a user to interact with, for example, a server application from the server system 30 and/or the merchant 12.

In an embodiment, the electrical connector 312 is a receptacle configured to receive the corresponding electrical connector 214 of the EV 200 (shown in FIG. 2). In other embodiments, the electrical connector 312 may be a plug configured to be received by a corresponding receptacle, such as the electrical connector 214, of the EV 200. In an embodiment, the electrical connector 312 may be integrated in the CS 34 without the use of the charging cable 314. In another embodiment, the electrical connector 312 may be an inductive charging coil configured to wirelessly transfer electronic data and electrical energy. In some embodiments, the CS 34 may be configured to provide one hundred and twenty (120) volts of alternating current (VAC), two hundred and forty (240) VAC, direct current (DC), or any other form of electrical energy to the EV 200.

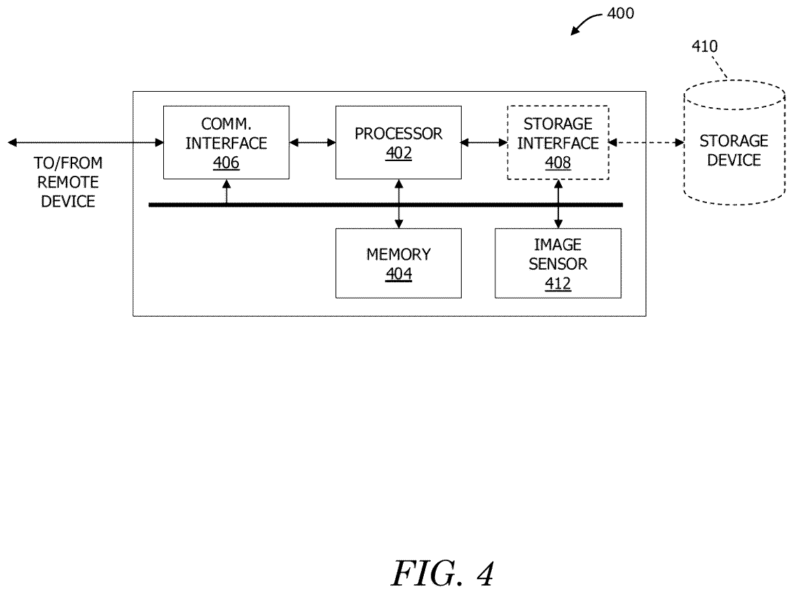

FIG. 4 is an example configuration of a server system 400, such as the server system 30 (shown in FIG. 1) and/or server systems of the acquirer 14 and/or issuer 18. The server system 400 includes, but is not limited to, the database 26 (shown in FIG. 1).

In the example embodiment, the server system 400 includes a processor 402 for executing instructions. The server system 400 further includes a memory device 404, in which the instructions may be stored. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C #, C++, Java, or other suitable programming languages, etc.).

The processor 402 is operatively coupled to a communication interface 406 such that the server system 400 can communicate with remote computing devices, such as the computing systems 32 and 300 (shown in FIGS. 2 and 3, respectively) or another server system. For example, the communication interface 406 may receive communications from the vehicle system 32 via the network 20 (shown in FIG. 1), such as the Internet.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the database 26. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory device 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Computer-Implemented Methods

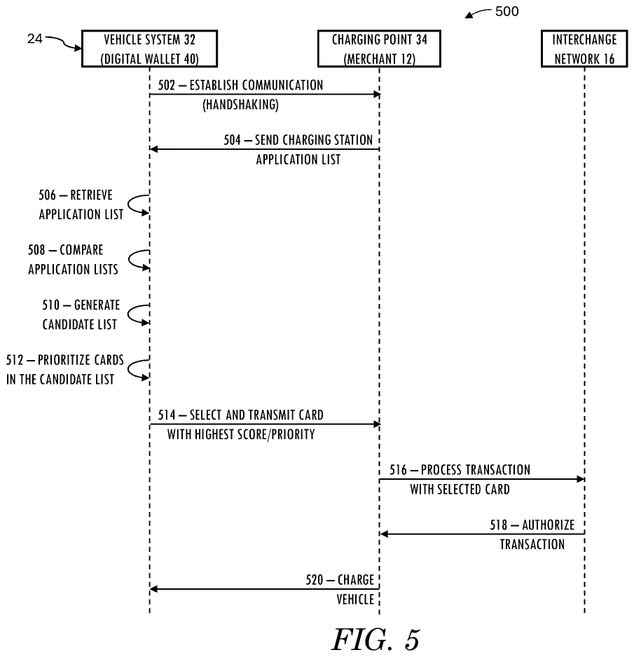

FIG. 5 is a process flow diagram for a process 500 for an electrical energy charging transaction between the electric vehicle (EV) 24 (shown in FIG. 1) and a charging station (CS) 34 (shown in FIG. 1) operated by the merchant 12 (shown in FIG. 1), in accordance with an aspect of the present disclosure. The process 500 is described below, for ease of reference, as being executed by exemplary devices and components introduced with the embodiments illustrated in FIG. 1-4. In one embodiment, the process 500 may be implemented by the system 10 (shown in FIG. 1). The process 500 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

In the exemplary embodiment, the process 500 extends and enhances the established principles of application selection in EMV payment systems, adapting them for digital frameworks like Secure Remote Commerce (SRC) and 3D Secure (3DS). The process 500 provides contactless application selection that is well suited for unattended terminals, such as a CS 34. The process 500 provides a plurality of new data elements and a unique flow for a card-based payment specification for EV charging. The process 500 may co-exist and run on top of the ISO 15118 standard, which specifies a digital communication protocol between an electric vehicle and a charging station. In this unique process 500, the EV 24 functions as the client and the CS 34 functions as the server. The process 500 eliminates the need for manual user intervention and ensures seamless operation in unattended environments such as EV charging stations. The structured process 500 includes candidate list generation, card prioritization, and final card selection, all while maintaining flexibility and scalability for multiple frameworks.

The process 500 begins when the EV 24 is connected to the CS 34. As shown in FIG. 5 at 502, a communication channel is established between the EV 24 and the CS 34 as part of a handshaking procedure. It is noted that messages exchanged between the EV 24 and the CS 34 may conform to the International Organization for Standardization (ISO) Standard 15118, vehicle to grid communication interface, which is the ISO standard for systems that exchange electronic messages between an electric vehicle and an electric grid. In the example embodiment, the handshaking procedure may include a plurality of ISO 15118 type messages.

The handshaking procedure is initiated to authenticate and establish trust between the EV 24 and the CS 34. The handshaking may involve the exchange of digital certificates, cryptographic keys, and secure session parameters to create a mutually authenticated and encrypted communication channel. For example, in an embodiment, the EV 24 and the CS 34 may exchange device certificates, which are validated using a Public Key Infrastructure (PKI). The certificates may ensure that both parties are legitimate entities and can securely communicate without risk of impersonation. After the certificates are verified, a session key may be negotiated, for example, using a key exchange protocol, as is known in the art. The key may be used to encrypt subsequent data exchanges, providing confidentiality and integrity throughout the communication session.

At 504, the CS 34 transmits a charging station application list to the EV 24, and more particularly, to the vehicle system 32. The charging station application list is a structured list of supported payment applications, made up of applications/brands of transaction cards the CS 34 can process. The supported payment applications may be referred to as srcAids, a new data structure/element that may be used in the context of an SRC system. In the example embodiment, an srcAid consists of two components: an Issuer Identifier, typically formatted as a case-sensitive Uniform Resource Identifier (URI); and a Payment Card Descriptor, which identifies the transaction card brand (e.g., Mastercard, Visa). In an embodiment, the charging station application list may be packaged into a structured format, such as JSON or XML, to optimize communication and reduce latency.

An srcAid includes the data element pair {IssuerIdentifier, PaymentCardDescriptor}, an example of which is:
{https://mastercardSrcSystem.com, Maestro}

This srcAid on the CS 34 indicates that Maestro branded transaction cards that have been digitized in the Mastercard SRC system can be accepted and processed by the CS 34.

In the example, the IssuerIdentifier is a case sensitive URI using the https scheme that contains the scheme and full qualified domain name of the host only in the format “https://srcsystem1.com.” In an example, the identifier “https://mastercardSrcSystem.com” may be used to indicate the Mastercard operated SRC system, while the identifier “https://visaSrcSystem.com” could be used to indicate the Visa operated SRC system. The PaymentCardDescriptor is a string carrying the name of a supported card brand, for instance “Mastercard”, “Maestro”, “VisaDebit,” or “Cartes Bancaires.”

In an example, the charging station application list may include the following list of brands that the CS 34 can process for the Mastercard SRC system: “Mastercard,” “Maestro,” and “Bancontact.” At the same time, the CS 34 may also process the following brands for the Visa SRC system: “VisaDebit” and “Cartes Bancaires.” Using these example, the charging station application list of srcAids would be:
{https://mastercardSrcSystem.com, Mastercard}
{https://mastercardSrcSystem.com, Maestro}
{https://visaSrcSystem.com, VisaDebit}
{https://visaSrcSystem.com, Cartes Bancaires}

In one embodiment, it may be more efficient to group the brands per SRC system and communicate them to the EV 24 as follows:
{https://mastercardSrcSystem.com, [Mastercard, Maestro]}
{https://visaSrcSystem.com, [VisaDebit, Cartes Bancaires]}

The combination of an IssuerIdentifier and the set of PaymentCardDescriptors that are accepted for the SRC system corresponding to the IssuerIdentifier is referred to as a srcSystemProfile. The srcSystemProfile is a new data structure/element that may be used in the context of an SRC system.

The set of srcSystemProfiles is referred to as an srcSystemProfileSet, which is a new data structure/element that may be used in the context of an SRC system. The srcSystemProfileSet may be denoted as [srcSystemProfile1, srcSystemProfile2, . . . ] . As used herein, the srcSystemProfiles may also be referred to as the charging station application list. Using the examples discussed above, the srcSystemProfileSet would be:
[
{https://mastercardSrcSystem.com, [Mastercard, Maestro]},
{https://visaSrcSystem.com, [VisaDebit, Cartes Bancaires]}
]

After receiving the charging station application list from the CS 34, the vehicle system 32 retrieves the list of vehicle applications or digitized cards from, for example, the memory device 204 (shown in FIG. 2). The vehicle system 32 has its own list of applications or SRC application definition file (ADF) names (srcAdfNames). The srcAdfNames represent different payment methods or accounts available for use in a payment transaction. The srcAdfName is a new data structure/element that may be used in the context of an SRC system. In the example embodiment, each srcAdfName consists of two components: an Issuer Identifier, typically formatted as a case-sensitive Uniform Resource Identifier (URI); and a Payment Card Descriptor, which identifies the transaction card brand (e.g., Mastercard, Visa). For example, the srcAdfName {https://visaSrcSystem.com, Cartes Bancaires} indicates a transaction card with a Cartes Bancaires brand that has been digitized in the SRC System operated by Visa. In addition to its srcAdfName, a digitized card also has an identifier, known as the srcDigitalCardId. In an example, an srcDigitalCardId is a string with a maximum of thirty-six (36) characters that represent a primary account number (PAN) or payment token.

An srcCard, which is also a new data structure/element that may be used in the context of an SRC system, may be identified by the pair {srcAdfName, srcDigitalCardId}, which is the equivalent of the tuple {IssuerIdentifier, PaymentCardDescriptor, srcDigitalCardId}. An example of such tuple is given below:
{https://visaSrcSystem.com, Cartes Bancaires,
9170430209a740e284004a442ec63356}

In an example, the list of vehicle applications may include the following list of srcCards:
{https://mastercardSrcSystem.com, Maestro,
df56839697854277b37036de87f44346}
{https://mastercardSrcSystem.com, Bancontact,
b6b989beb6b642599bb5cf9daa7682fe}
{https://amexSrcSystem.com, Amex,
7fcc4b44f22d45d49813dacb7ae0ed54}

Each of the srcCards above represents a different payment method or account, i.e., a different physical card that has been digitized into SRC systems and that is available for an EV charging transaction.

At 508, the vehicle system 32 compares the charging station application list (or srcSystemProfileSet) to the list of vehicle applications or digitized cards retrieved from the memory device 204. For example, in the exemplary embodiment, the vehicle system 32 compares its list of srcCards against the srcAids (i.e., the entries in the srcSystemProfileSet supported by the CP 34). Specifically, the vehicle system 32 matches the srcAdfName of each transaction card against the srcAids derived from the srcSystemProfileSet. An srcAdfName matches an srcAid if both the IssuerIdentifier and the PaymentCardDescriptor are the same. The matching process involves case-sensitive comparisons for issuer identifiers and case-insensitive comparisons for payment card descriptors. For example, an IssuerIdentifier of “https://mastercardSrcSystem.com” is not the same as an IssuerIdentifier of “https://mastercardsrcsystem.com.” The payment card descriptors, however, are the same if the brand they refer to is the same. This comparison is case insensitive, such that “MASTERCARD,” “Mastercard,” and “mastercard” are the same.

As a first step of the comparison, the vehicle system 32 first eliminates srcCards associated with SRC systems that are not supported by the CS 34. For example, srcCards that have an IssuerIdentifier that does not appear in the srcSystemProfileSet are eliminated. For example, in the example list of srcCards above, the vehicle system 32 would remove the Amex card from the list for the transaction, as the IssuerIdentifier “https://amexSrcSystem.com” does not appear in the srcSystemProfileSet retrieved from the CS 34. The CS 34 cannot process cards that have been digitized in the SRC system operated by Amex. In the example, the vehicle system 32 would therefore retain the list of srcCards below:
{https://mastercardSrcSystem.com, Maestro,
df56839697854277b37036de87f44346}
{https://mastercardSrcSystem.com, Bancontact,
b6b989beb6b642599bb5cf9daa7682fe}

As a second step of the comparison, for each remaining srcCard, the vehicle system 32 takes the set of PaymentCardDescriptors from the srcSystemProfileSet that have a matching IssuerIdentifier and checks whether the PaymentCardDescriptor of the srcCard matches. If not, the srcCard is removed from the retained list of srcCards. In the example above, the set of PaymentCardDescriptors from the srcSystemProfileSet is Mastercard and Maestro. From the retained list of srcCards, the vehicle system 32 eliminates the Bancontact srcCard from the retained list of srcCards, as the PaymentCardDescriptor does not appear in the srcSystemProfileSet for the specific IssuerIdentifier.

At 510, after the first and second step of the comparison are completed, the vehicle system 32 generates a candidate list of srcCards that may be used in the transaction. For example, using the list of retained srcCards from the comparison step, the candidate list is generated by including one or more srcAdfNames in the candidate list. Specifically, the srcAdfNames corresponding to the remaining srcCards are included in the candidate list. The candidate list is a list of common applications, in the form of a list of srcAdfNames of transaction cards that may be used for payment at the CS 34. In the example above, the candidate list includes a single entry, namely {https://mastercardSrcSystem.com, Maestro}. Consequently, the identifier of the associated srcCard, i.e. srcDigitalCardId df56839697854277b37036de87f44346, will be used for further processing and authorization.

At 512, when the candidate list includes more than one (1) entry, the vehicle system 32 prioritizes the candidate list or the available digitized cards based on one or more predefined rules. The predefined rules may be configured during the card digitization process and may be tailored to align with user preferences or specific use cases. For example, in the example embodiment, a user may assign higher priority to primary credit cards over debit or prepaid cards, ensuring that the most suitable card according to the user is selected for the transaction. The prioritization process involves assigning a priority score to each transaction card digitized and stored in the digital wallet 40, with lower numerical scores indicating higher priority. For example, in an embodiment, a user may assign priorities as follows: i) priority 1—default or primary credit card; ii) priority 2—debit card; and iii) priority 3—prepaid or secondary cards.

At 514, the vehicle system 32 selects the card with the highest priority and transmits the selected card to the CS 34 for processing the transaction. In the exemplary embodiment, when the candidate list contains more than one entry, the vehicle system 32 uses the priority to choose between entries, selecting the card with the highest priority. The vehicle system 32 presents the selected highest priority srcAdfName for use in the transaction.

Alternatively or additionally, the transaction card prioritization and selection process may be adapted to include the use of labels. While the assigned priority approach described above works in many instances, the approach cannot account for specific situations where a transaction card with a lower priority value than another would provide more benefits to the consumer 22. For example, using the lower priority card may be appropriate for the transaction when the transaction card is co-badged and/or otherwise affiliated with the merchant 12 or when the issuer 18 has established a loyalty (or other business) arrangement or affiliation with the merchant 12. As an example, transaction cards co-badged with “CostCo” provide benefits to the consumer 22 when used at CostCo. Similarly, some issuers, such as issuer 18, may partner with various retailers, airlines, and other businesses to offer rewards cards and/or other benefits for use of their transaction cards. Accordingly, the consumer 22 may want to use a specific transaction card for a particular EV charging transaction, while in other circumstances the consumer 22 would typically use the ‘default card’based on the assigned priority approach described above.

The use of labels requires additional information to be added to the srcAids in the CS 34 and to the srcCards in the digital wallet 40 of the vehicle system 32. The additional information is expressed as an optional set of strings, referred to as labels. For example, for a CostCo operated charging station, the set of strings could include the label “CostCo.” For a merchant, such as the merchant 12, that has a business arrangement with U.S. Bank, the set of strings may include the label “U.S. Bank.”

Using the example above, the srcSystemProfileSet of the CS 34 may include one or more labels as follows:
[
{https://mastercardSrcSystem.com, [Mastercard, Maestro], [CostCo, U.S. Bank]},
{https://visaSrcSystem.com, [VisaDebit, Cartes Bancaires]}
]

Note that the labels “CostCo” and “U.S. Bank” are placed at the level of the IssuerIdentifier (i.e., https://mastercardSrcSystem.com), as this placement provides the best compromise between flexibility and overhead.

If the one or both of the labels only apply to one PaymentCardDescriptor, the corresponding entry can easily be split, as illustrated below.
[
{https://mastercardSrcSystem.com, [Mastercard], [CostCo, U.S. Bank]},
{https://mastercardSrcSystem.com, [Maestro]},
{https://visaSrcSystem.com, [VisaDebit, Cartes Bancaires]}
]

In an embodiment, to facilitate avoiding confusion between the PaymentCardDescriptors and the labels, the srcSystemProfileSet may be formatted as a JSON structure, as illustrated below, where “labelSet” includes the labels.
“srcSystemProfileSet”:[{
   “issuerIdentifier”:{“uri”:“https://visaSrcSystem.com”},
   “paymentCardDescriptorSet”:[
      {“paymentCardDescriptor”:“Cartes Bancaires”},
      {“paymentCardDescriptor”:“VisaDebit”}]}, {
   “issuerIdentifier”:{“uri”:“https://mastercardSrcSystem.com”},
   “paymentCardDescriptorSet”:[
      {“paymentCardDescriptor”:“Mastercard”},
      {“paymentCardDescriptor”:“Maestro”}],
   “labelSet”:[
      {“label”: “Costco”},
      {“label”: “U.S. Bank”}]
}]

Similarly, the srcCard of the digital wallet 40 may include one or more labels as follows:
{https://mastercardSrcSystem.com, Maestro,
df56839697854277b37036de87f44346, [CostCo]}
{https://mastercardSrcSystem.com, Bancontact,
b6b989beb6b642599bb5cf9daa7682fe, [U.S. Bank]}
{https://amexSrcSystem.com, Amex,
7fcc4b44f22d45d49813dacb7ae0ed54}

In this example, the “Maestro” cards have the “CostCo” label and the “Bancontact” card has the label of its issuer, “U.S. Bank.”

In an embodiment, the set of srcCards included in the digital wallet 40 may be formatted as a JSON structure, as illustrated below, where “labelSet” includes the labels.
Cards: [
{
   “srcDigitalCardId”: “28d25c71-ef65-4e9c-a118-b986d4a294dd”,
   “srcAdfName”: {
      “issuerIdentifier”: {“uri”: “https://visaSrcSystem.com”}, “paymentCardDescriptor”: {“paymentCardDescriptor”: “VisaDebit”}}
}, {
   “srcdigitalcardid”: “04647497-6f09-4934-878e-60f533dfe6d3”,
   “srcAdfName”: {
      “issuerIdentifier”: {“uri”: “https://mastercardSrcSystem.com”},
      “paymentCardDescriptor”: {“paymentCardDescriptor”: “Maestro”}},
   “labelSet”: [{“label”:”CostCo”} ]
}, {
   “srcDigitalCardId”: “421256e2-f2dd-4952-b106-b1c6f20decb2”,
   “srcAdfName”: {
      “issuerIdentifier”: {“uri”: “https://mastercardSrcSystem.com”},
      “paymentCardDescriptor”: {“paymentCardDescriptor”: “Mastercard”}},
   “labelSet”: [{“label”: “U.S. Bank”} ]
}, {
   “srcDigitalCcardId”: “f102d1c8-85b2-48c1-804a-0530835fc80b”,
   “srcAdfName”: {
      “issuerIdentifier”: { “uri”: “https://visaSrcSystem.com”},
      “paymentCardDescriptor”: { “paymentCardDescriptor”: “Cartes Bancaires”} }
}, {
   “srcDigitalCardId”: “c819439c-bff8-45a0-a73e-c976cde031d9”,
   “srcAdfName”: {
      “issuerIdentifier”: { “uri”: “https://mastercardSrcSystem.com”},
      “paymentCardDescriptor”: { “paymentCardDescriptor”: “Bancontact”}}
}]

In an embodiment using labels, at 512, when the candidate list includes more than one (1) entry, the vehicle system 32 prioritizes the candidate list or the available digitized cards based on the one or more predefined rules. For example, in the “labels” embodiment above, if one or more transaction cards have one or more labels, the vehicle system 32 compares each of the transaction cards having labels and each such label against corresponding entries in the srcSystemProfileSet. For each match with a label, the vehicle system 32 adds one (1) point to a score for that transaction card. In this example, label matching is case insensitive. This is, labels match if the string representation is the same, irrespective of letter case.

The vehicle system 32 has now a candidate list with a score associated with each srcCard. The score may be in a range between and including zero (0) and n, where n indicates the highest number of matching labels for a particular card. The vehicle system 32 selects the srcCard with the highest score as the srcCard to use in the transaction. If two or more srcCards have the same score and that score is the highest score, the vehicle system 32 uses the priority value to determine which transaction card to select. If none of the eligible transaction cards have a label or none of the corresponding entries in the srcSystemProfileSet have a label, the vehicle system 32 chooses the srcAdfName with the highest priority using the assigned priority approach described above.

At 516, upon receiving the transaction card from the vehicle system 32, the CS 34 transmits an authorization request to the interchange network 16. The authorization request may include a transaction amount due (or a hold amount) for the charging transaction and payment information associated with the selected transaction card received from the vehicle system 32. For example, the payment information may include a token stored by vehicle system 32 in the digital wallet 40. In an embodiment, a server of the payment network, such as the server system 30 (shown in FIG. 1), may generate transaction information based on the authorization request and transmit the transaction information to an issuer associated with the consumer's payment information, such as the issuer 18. The issuer 18 may process the transaction information to pre-authorize the payment amount included in the transaction information. The issuer 18 may parse the transaction information to identify a PAN associated with the payment account of the consumer 22 (shown in FIG. 1). The issuer 18 may subsequently determine whether the transaction card account 28 includes sufficient available funds for processing the transaction. If the transaction card account 28 includes sufficient funds to complete the transaction, the issuer 18 may determine that pre-authorization is successful and may send a pre-authorization success message to the server system 30. Otherwise, the issuer 18 may determine that the pre-authorization has failed and may send a pre-authorization failure message to the server system 30.

At 518, upon receiving a pre-authorization success message from the issuer 18, the interchange network 16 (via the server system 30, for example) transmits a message to the CS 34 (via the acquirer 14 in some embodiments) indicating that the pre-authorization was successful. If the message received by the CS 34 indicates that pre-authorization was successful, at 520, the CS 34 begins the charging process. The charging process may be permitted and monitored by the vehicle system 32. The charging process may also be monitored by the CS 34. The consumer 22 may be notified of the charging status and the estimated time to complete the charging. In some embodiments, the CS 34 may also provide additional services such as battery health diagnostics and maintenance recommendations. In some embodiments, after charging is complete, the CS 34 may transmit a report to the merchant 12 indicating a final amount to charge the transaction card account 28 of the consumer 22.

Alternatively, upon receiving a pre-authorization failure message from the issuer 18, the interchange network 16 (via the server system 30) may send a failure message to the CS 34 indicating that the pre-authorization was not successful. Upon receiving the failure message, the consumer 22 may manually select a different payment method stored in the digital wallet 40 and re-submit the transaction information (including information identifying the different payment method); otherwise, the transaction is declined.

Although FIG. 5 shows example steps of process 500, in some implementations, process 500 may include additional steps, fewer steps, different steps, or differently arranged steps than those depicted in FIG. 5. Additionally or alternatively, two or more of the steps of process 500 may be performed in parallel. For example, the lists comparison at 508, candidate list generation at 510, and/or the prioritization of candidate list cards at 512 may be performed substantially simultaneously. The process 500 may also be customized based on the consumer's and/or merchant's preferences and the specific capabilities of the devices involved.

The disclosure provides a scalable and interoperable solution for electric vehicle charging environments and other unattended transaction use cases. Advantages of the above process include employing new data elements and structured data formats to facilitate the unattended exchange and selection of payment application data between a charging station and an electric vehicle. The disclosure provides for an unattended vehicle charging transaction by eliminating manual intervention, reducing latency, and ensuring that the most suitable payment method is used for each transaction, while integrating with existing EV communication standards, such as ISO 15118.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. An electric vehicle (EV) computing system comprising:
one or more processors; and
a memory device storing one or more transaction cards thereon,
the memory device further having computer-executable instructions stored thereon, which when executed by the one or more processors, causes the one or more processors to:
establish a communication channel with a charging station (CS) computing system via one or more communication protocols;
receive a list of supported payment applications from the CS computing system;
retrieve the stored one or more transaction cards from the memory device;
match the stored one or more transaction cards to the list of supported payment applications;
based on the matching, generate a candidate list of transaction cards compatible with the CS computing system;
prioritize the candidate list of transaction cards based on one or more predefined rules; and
select a prioritized transaction card for processing a transaction at the CS computing system.

2. The EV computing system of claim 1,
the one or more communication protocols including the ISO 15118 standard.

3. The EV computing system of claim 1,
the step of prioritizing the candidate list of transaction cards including:
prioritizing the candidate list of transaction cards based on a predefined hierarchy of payment methods stored in the memory device.

4. The EV computing system of claim 1,
the step of prioritizing the candidate list of transaction cards including:
identifying one or more first labels associated with each transaction card in the candidate list,
matching the first labels to one or more second labels defined in the list of supported payment applications, and
computing a score for each transaction card based on a number of label matches,
the step of selecting the prioritized transaction card including selecting the transaction card having the highest score.

5. The EV computing system of claim 4,
the first and second labels being assigned to the one or more transaction cards and payment applications as strings, each label being representative of an affiliation with one or more merchants and financial institutions.

6. The EV computing system of claim 1,
the computer-executable instructions, when executed by the one or more processors, further cause the one or more processors to:
transmit payment information associated with the prioritized transaction card to the CS computing system for transaction authorization.

7. The EV computing system of claim 6,
the payment information including a token stored in the memory device.

8. The EV computing system of claim 1,
the memory device including a digital wallet, the digital wallet storing the one or more transaction cards therein.

9. The EV computing system of claim 1,
the step of matching the stored one or more transaction cards including:
comparing a first issuer identifier of each stored transaction card to one or more second issuer identifiers in the received list of supported payment applications,
eliminating each stored transaction card whose first issuer identifier does not match one of the second issuer identifiers,
for each remaining stored transaction card, comparing a first payment card descriptor of each remaining stored transaction card to one or more second payment card descriptors in the received list of supported payment applications for the matching second issuer identifier, and
eliminating each remaining stored transaction card whose first payment card descriptor does not match one of the second payment card descriptors.

10. The EV computing system of claim 9,
the step of comparing the first issuer identifier being performed in a case-sensitive manner, and
the step of comparing the first payment card descriptor being performed in a case-insensitive manner.

11. A method comprising:
establishing a communication channel between an electric vehicle (EV) computing system and a charging station (CS) computing system via one or more communication protocols;
receiving, by the EV computing system, a list of supported payment applications from the CS computing system;
retrieving, by the EV computing system, one or more stored transaction cards from a memory device of the EV computing system;
matching, by the EV computing system, the one or more stored transaction cards to the list of supported payment applications;
based on the matching, generating, by the EV computing system, a candidate list of transaction cards compatible with the CS computing system;
prioritizing, by the EV computing system, the candidate list of transaction cards based on one or more predefined rules; and
selecting, by the EV computing system, a prioritized transaction card for processing a transaction at the CS computing system.

12. The method in accordance with claim 11,
the one or more communication protocols including the ISO 15118 standard.

13. The method in accordance with claim 11,
the step of prioritizing the candidate list of transaction cards including:
prioritizing the candidate list of transaction cards based on a predefined hierarchy of payment methods stored in the memory device of the EV computing system.

14. The method in accordance with claim 11,
the step of prioritizing the candidate list of transaction cards including:
identifying one or more first labels associated with each transaction card in the candidate list,
matching the first labels to one or more second labels defined in the list of supported payment applications, and
computing a score for each transaction card based on a number of label matches,
the step of selecting the prioritized transaction card including selecting the transaction card having the highest score.

15. The method in accordance with claim 14,
the labels being assigned to the one or more transaction cards and payment applications as strings, each label being representative of an affiliation with one or more merchants and financial institutions.

16. The method in accordance with claim 11, further comprising:
transmitting, by the EV computing system, payment information associated with the prioritized transaction card to the CS computing system for transaction authorization.

17. The method in accordance with claim 16,
the payment information including a token stored in the memory device of the EV computing system.

18. The method in accordance with claim 11,
the EV computing system storing the one or more transaction cards in a digital wallet associated with the EV computing system.

19. The method in accordance with claim 18,
the step of matching the one or more stored transaction cards including:
comparing a first issuer identifier of each stored transaction card to one or more second issuer identifiers in the received list of supported payment applications,
eliminating each stored transaction card whose first issuer identifier does not match one of the second issuer identifiers,
for each remaining stored transaction card, comparing a first payment card descriptor of each remaining stored transaction card to one or more second payment card descriptors in the received list of supported payment applications for the matching second issuer identifier, and
eliminating each remaining stored transaction card whose first payment card descriptor does not match one of the second payment card descriptors.

20. The method of claim 19,
the step of comparing the first issuer identifier being performed in a case-sensitive manner, and
the step of comparing the first payment card descriptor being performed in a case-insensitive manner.
